(19) United States
(12) Patent Application Publication
(10) Pub. No.: US 2019/0172113 A1
(43) Pub. Date: Jun. 6, 2019

(54) CLASSIFIED AD ENABLEMENT

(71) Applicant: Walmart Apollo, LLC, Bentonville, AR (US)

(72) Inventors: Courtland J. Halbrook, Centerton, AR (US); Nicholaus A. Jones, Fayetteville, AR (US); Matthew A. Jones, Bentonville, AR (US)

(21) Appl. No.: 16/302,547

(22) PCT Filed: May 17, 2017
(86) PCT No.: PCT/US2017/033095

§ 371 Date: Nov. 16, 2018

Related U.S. Application Data
(60) Provisional application No. 62/337,481, filed on May 17, 2016.

(51) Int. Cl. G06Q 30/06; G06Q 20/08; G06Q 20/20

(52) U.S. Cl. CPC G06Q 30/0617; G06Q 30/0627; G06Q 20/20; G06Q 20/0855; G06Q 30/0639

(57) ABSTRACT

In some embodiments, system, apparatuses, and methods are provided herein useful to leveraging an existing point of sale system to facilitate sale of a product by a third party seller. In some embodiments, the system comprises an existing point of sale system, the existing point of sale system configured to receive, from a third party seller, information about a product, establish an entry for the product based on the product information, receive an indication of a retail shopping facility in which to house the product, receive payment from the buyer, and provide, to the third party seller, value related to the payment from the buyer, the retail shopping facility configured to present, to the buyer on behalf of the third party seller, the product.

### CROSS-REFERENCE TO RELATED APPLICATION

This application claims the benefit of U.S. Provisional Application No. 62/337,481, filed May 17, 2016, which is incorporated herein by reference in its entirety.

### TECHNICAL FIELD

This invention relates generally to systems for purchasing goods and services and, more particularly, to systems for completing transactions between buyers and sellers.

### BACKGROUND

Over the last several years, multiple forums for buyers and sellers to interact and buy and sell products have emerged. For example, websites exist where sellers can offer products and services for sale and buyers can purchases these products and services. With respect to the purchase of products, the buyer and seller must eventually meet in person so that the buyer can provide compensation to the seller and receive the product. This presents a potentially hazardous situation for buyers and sellers. Additionally, the forums through which the buyers and sellers interact often lack oversight and regulation. Consequently, a need exists for a safer and more convenient means for buyers and sellers to conduct transactions.

### BRIEF DESCRIPTION OF THE DRAWINGS

Disclosed herein are embodiments of systems, apparatuses, and methods pertaining to leveraging an existing point of sale system to facilitate sale of a product by a third party seller. This description includes drawings, wherein:

FIG. 1 is a block diagram of a system for leveraging a point of sale system 108 to facilitate sale of a product by a seller 104, according to some embodiments.

FIG. 2 is an example graphical user interface (GUI) 200 useful for buying and selling products, according to some embodiments.

FIG. 3 is a flow chart depicting example operations for leveraging a point of sale system to facilitate sale of a product by a seller.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to leveraging an existing point of sale system to facilitate a sale of a product by a third party seller. In some embodiments, the system comprises an existing point of sale system, the existing point of sale system configured to receive, from a third party seller, information about a product, establish an entry for the product based on the product information, receive an indication of a retail shopping facility in which to house the product, receive payment from the buyer, and provide, to the third party seller, value related to the payment from the buyer, the retail shopping facility configured to present, to the buyer on behalf of the third party seller, the product.

As previously discussed, forums exist through which buyers and sellers can interact to buy and sell products and services. The existing forums however include multiple drawbacks. For example, many of these forums, such as websites, lack oversight and regulation. Even more problematic is that existing forums require buyers and sellers to meet in person to conduct a sale. Buyers and sellers can be reluctant to meet or worried about meeting due to possible dangers associated with meeting a stranger to conduct a transaction. For example, a nefarious buyer or seller can use the sale as a ruse to take advantage of the other party, such as by fraud, theft, or worse. Described herein are systems, apparatuses, and methods that help facilitate such transactions. Some embodiments lessen or eliminate some of the drawbacks of current approaches. For example, existing facilities can be utilized to eliminate the need for buyers and sellers to meet in person to conduct a sale. Additionally, existing point of sale systems can be utilized to make transactions easier for buyers and seller as well as reduce or eliminate the risk of fraud and/or theft.

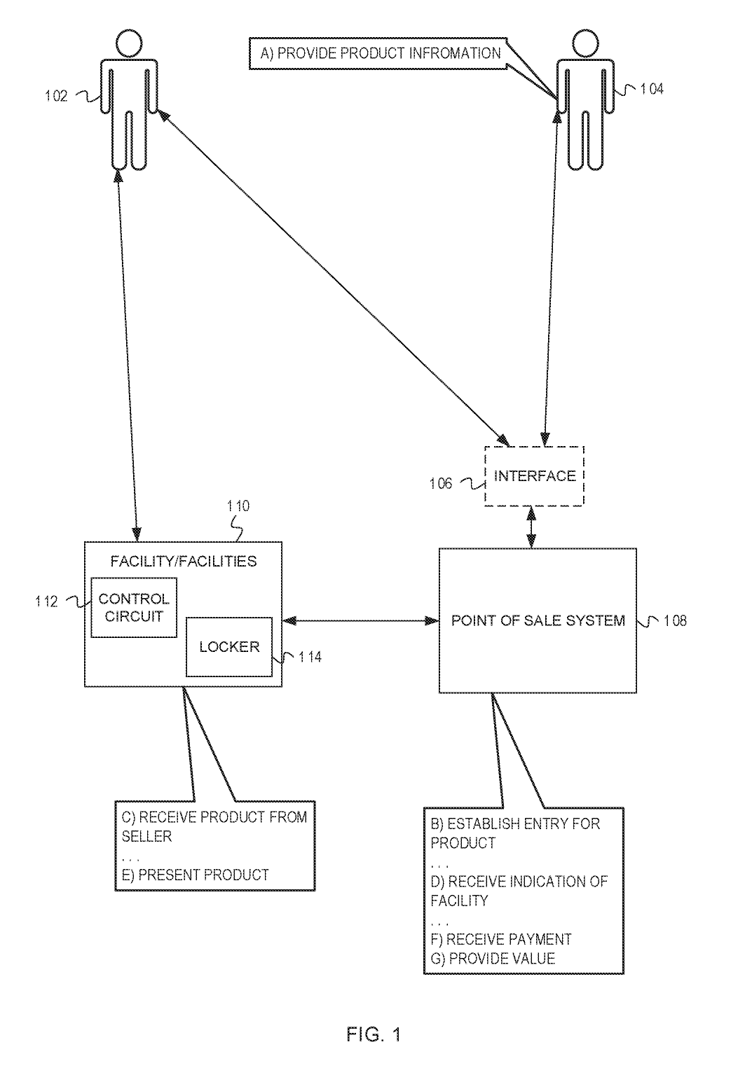

FIG. 1 is a block diagram of a system for leveraging a point of sale system 108 to facilitate sale of a product by a seller 104, according to some embodiments. The system includes a point of sale system 108 and a facility 110. The seller 104 and the buyer 102 interact with the system via, for example, an interface 106 such as a web interface or directly via the point of sale system 108. FIG. 1 depicts operations at stages A-G. The stages are examples and are not necessarily discrete occurrences over time (e.g., the operations of different stages may overlap). Additionally, FIG. 1 is an overview of example operations.

At stage A, the seller 104 provides product information to the point of sale system 108. In some embodiments, the seller 104 provides the product information to the point of sale system 108 via the interface 106. As one example, the interface 106 can be a web interface such as a website and the seller 104 can provide the product information via the website. The product information can include a description of the product, a type of the product, a price for the product, information associated with the seller (e.g., identification information, location information, etc.), etc. In some embodiments, the seller is a third party seller in that the seller is not affiliated with a retailer associated with the point of sale system 108. Additionally, the interface 106 can provide the seller 104 with the ability to reserve a secure location within the facility 110 to store the product.

At stage B, the point of sale system 108 establishes an entry for the product. In some embodiments, the point of sale system 108 is an existing point of sale system, such as a point of sale system 108 utilized by a retailer. The point of sale system 108 can include a computer system comprising one or more computers (e.g., including processors, memory, control circuits, etc.), servers, network devices, etc. The point of sale system 108 can establish an entry for the product by assigning an identifier (such as a stock keeping unit (SKU)) to the product. The point of sale system 108 can enter the product into a retailer's database of products. In some embodiments, the point of sale system 108 enters the product into the retailer's database so that the product can be treated like any other product sold by the retailer. The point of sale system 108 can also provide a barcode or other identifier for the product so that the product can be purchased via the point of sale system 108 in a manner similar to that of the retailer's other products.

At stage C, the facility 110 receives the product. In some embodiments, the facility 110 is a retail shopping facility such as a store. Alternatively, the facility 110 can be a warehouse, shipping area, or any other facility that is able to receive the product (e.g., a facility with a secure location, such as a locker, to house the product). The seller 104 can bring the product to the facility 110, or arrange for the product to be shipped to the facility 110. In some embodiments, the facility 110 includes a control circuit 112 and one or more lockers 114. The locker 114 can receive the product from the seller 104.

At stage D, the point of sale system 108 receives an indication of the facility in which the product should be located (i.e., the facility 110 in which the product should be housed). The seller 104 can provide this information or this information can be inferred by the seller's 104 act of providing the product to the facility 110. In some embodiments, the buyer 102 can provide this indication. For example, the buyer 102 may be interested in purchasing the product, but is not located near the facility 110 that received the product. The seller can provide an indication to relocate the product to another facility 110 (e.g., a second facility) by requesting that the product be transferred to another facility 110 (i.e., that transportation to the second facility be arranged). If the buyer 102, or seller 104, requests that the product be housed in a different facility 110, the system can arrange for the product to be transported from the facility 110 to another facility 110.

At stage E, the facility presents the product for sale. In some embodiments, the products are presented for sale only after the buyer 102 has requested to view the product to potentially purchase the product. For example, the product can be stored in the facility 110 (e.g., in a locker, stockroom, etc.) and the buyer 102 can request to view the product. The buyer 102 can request to view the product while at the facility 110 or can arrange to view the product. For example, the buyer 102 can arrange to view the product via the interface 106, the point of sale system 108, or the facility 110 (e.g., by calling the facility 110). In some embodiments, the product is additionally, or alternatively, presented online. For example, the product can be presented on a retailer's website either along with the retailer's other products or in an area dedicated to products being sold by third party sellers. Buyers may be able to search for and browse the products simultaneously with products offered directly by the retailer. Alternatively, the products can be presented on a website that is dedicated to buying and selling products between third party sellers and buyers. When products are presented online, the website can be considered a facility 110. Additionally, in some embodiments the locker 114 can present the product for sale.

At stage F, the point of sale system 108 receives payment for the product, for example, from the buyer 102. Because the point of sale system 108 established an entry for the product, the buyer 102 can purchase the product in a manner similar to other products sold by the retailer. If the buyer 102 purchases the product at a facility 110 which is a retail shopping facility, the buyer 102 can purchase the item at a terminal within the retail shopping facility along with other products that the buyer 102 is purchasing, whether sold by the retail shopping facility or third party sellers. In this regard, the point of sale system 108 provides a simple way for the buyer 102 to purchase the product sold by the seller 104. If the buyer 102 purchases the product online (e.g., via a retailer's website or a website designed to facilitate sales between third party sellers 104 and buyers 102), the buyer 102 purchases the product in a manner similar to that of purchasing any other products from the facility 110. Again, this provides a simple way for the buyer 102 to purchase the product sold by the seller 104. Not only does use of an existing point of sale system 108 make purchasing items easier for the buyer 102 and selling items easier for the seller 104, it also can reduce or eliminate the risk of fraud. Additionally, the point of sale system 108 can provide a greater number of payment options for the buyer 102 and a greater number of ways for the seller 104 to accept payment than traditional approaches offer.

At stage F, the point of sale system 108 receives payment, for example, from the buyer 102. The point of sale system 108 can accept payment in any suitable form. As previously discussed, this can provide a greater number of payment options for the buyer 102 that would be possible in a traditional face-to-face transaction.

At stage G, the point of sale system 108 provides value to the seller. After receiving the buyer's 102 payment in exchange for the product, the point of sale systems facilitates transmission of the payment to the seller 104. The point of sale system 108 can provide value to the seller 104 at the facility 110 in the form of cash (e.g., currency), credit, voucher, gift card, or other compensation redeemable for goods or services. The point of sale system 108 can provide value to the seller 104 at the facility 110 in which the product was housed and/or sold, or any other facility 110 associated with the point of sale system 108. For example, if the product was received at a facility 110 near the seller 104, but the buyer 102 purchased the product from a different facility that is far from the seller 104, the point of sale system 108 can provide value for the seller 104 at the facility 110 at which the product was received. If the buyer 102 purchased the product online, the point of sale system 108 can provide value to the seller 104 electronically (e.g., an electronic transfer of funds, credit to an online account, etc.) or provide value to the seller 104 at the facility 110.

Any number of methods can be used to determine an amount of the value to provide to the seller 104. For example, providing value to the seller 104 can be as simple as providing the seller with monetary value equal to the price paid by the buyer 102 for the product. Additionally, more complicated methods can be utilized. For example, if the point of sale system 108 is associated with a retail shopping facility, the seller 104 can choose to either receive a credit that can be used at the retail shopping facility (or its affiliates) in an amount equal to the price paid by the buyer 102 for the product, or monetary value (e.g., cash, prepaid card, etc.) in an amount less than the price paid by the buyer 102 for the product. In this regard, the retail shopping facility receives value from the transaction. If the seller 104 opts to receive the credit, the retail shopping facility benefits from the future purchase by the seller 104 using the credit. If the seller 104 opts to take the monetary value, the retail shopping facility benefits from a portion of the sale.

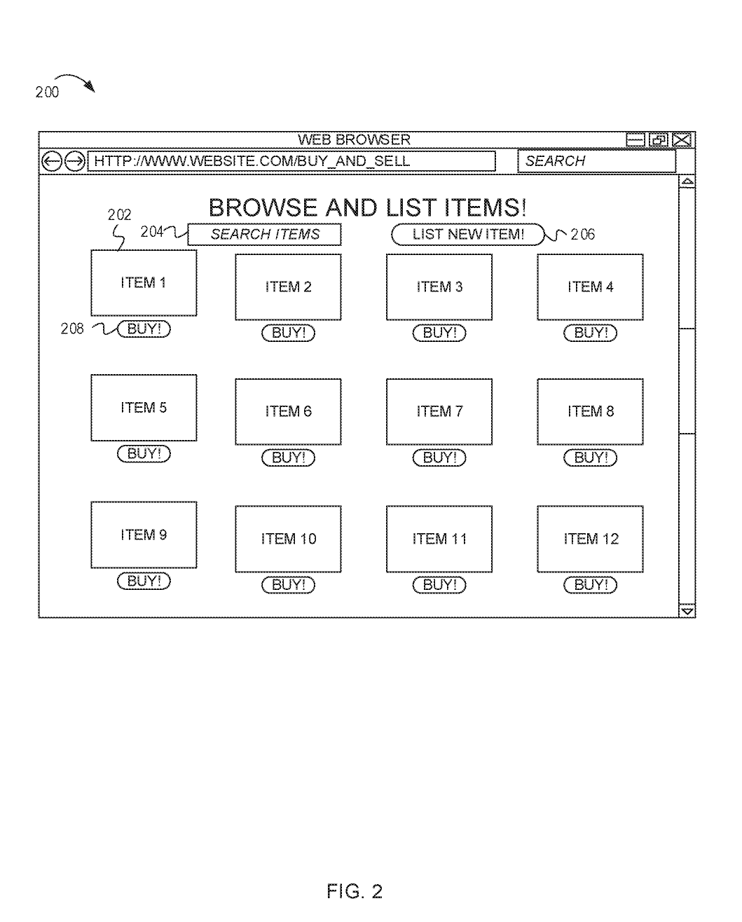

While FIG. 1 and the associated text describe a system for conducting sales, FIG. 2 depicts an example GUI for conducting sales.

FIG. 2 is an example GUI 200 useful for buying and selling products, according to some embodiments. The GUI 200 is depicted as being presented via a website. The GUI 200 includes a plurality of items 202 (i.e., products and/or services) that users can purchase. In some embodiments, users can purchase the items 202 via the GUI by, for example, selecting a “buy” indicator 208. Additionally, the GUI 200 can include a search bar 204 that allows users to enter search queries and search the items being sold. In some embodiments, the GUI 200 includes the ability for users to list items for sale. For example, the GUI 200 includes a “list new items button” 206. Selection of the list new items button may cause a new GUI to be presented that features tools useful for selling items. For example, the new GUI can include tools for receiving information about items (e.g., descriptions, images, prices, etc.) from users and allowing users to create for sale listing for the items.

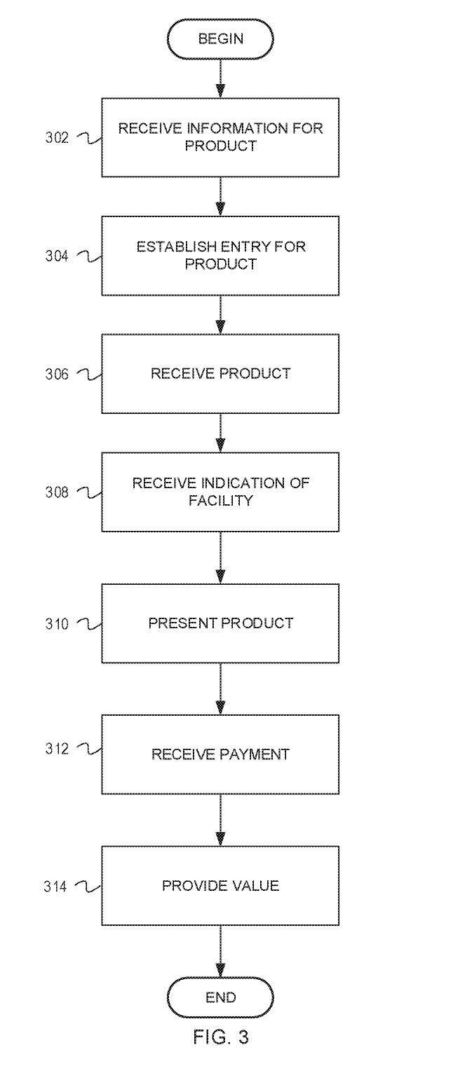

While FIG. 2 depicts an example GUI 200 for conducting sales, FIG. 3 is a flow chart depicting example operations for facilitating the sale of products by sellers.

FIG. 3 is a flow chart depicting example operations for leveraging a point of sale system to facilitate sale of a product by a seller. The flow begins at block 302.

At block 302, information for a product is received. For example, a point of sale system can receive information for the product from a seller. The seller can provide the information via a website, in a shopping facility, over the phone, etc. The information can include a description of the product, a type of the product, a cost of the product, information about the seller, etc. The flow continues at block 304.

At block 304, an entry for the product is established. For example, the entry for the product is established by the point of sale system. The point of sale system can create an entry for the product in a product database. The product database can be specific to items being sold by third party sellers or can include other items sold by a retailer associated with the point of sale system. The point of sale system can establish an entry for the product by assigning an identifier to the product and associating the information for the product with the identifier. Additionally, in some embodiments, the point of sale system (e.g., a server associated with the point of sale system) can create an entry for the product by listing the product on a website. The flow continues at block 306.

At block 306, the product is received. For example, a facility, such as a retail shopping facility or distribution location, can receive the product. The seller can drop the product off at the facility or the seller can ship the product to the facility. The flow continues at block 308.

At block 308, an indication of the facility is received. For example, the point of sale system can receive an indication of the facility. The indication of the facility indicates the facility in which the product should be housed. The indication of the facility can be received from the seller or the buyer. The flow continues at block 310.

At block 310, the product is presented. For example, the product can be presented at the facility. In some embodiments, the product is presented along with other merchandise at the facility. In other embodiments, the product is presented at the facility based on requests by potential buyers. For example, a potential buyer can request to view the product. Upon requesting to view the product, the facility can be make the product available to the potential buyer for viewing. The facility can make the product available for viewing by, for example, providing the potential buyer with information sufficient to access a locker or other secure area (e.g., a code). In embodiments in which the facility is a website, the facility can present the product by placing the product on the website. The flow continues at block 312.

At block 312, payment is received. For example, the point of sale system receives the payment from a buyer. In some embodiments, the point of sale system can receive payment for the product in a manner similar to which payment is received for products sold by a retailer associated with the point of sale system. The flow continues at block 314.

At block 314, value is provided. For example, the point of sale system can provide value to the seller. The point of sale system can provide value to the seller electronically (e.g., transferring value to an account associated with the seller) or by instructing an associate to provide monetary value (e.g., cash, a gift card, etc.) to the seller. The value can be an amount equal to, greater than, or less than the value of the payment received.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. For example, while the discussion above indicates that buyers and/or sellers can purchase and sell products online or in a facility, in some embodiments the buyer and/or seller may be required to visit the facility to purchase and/or provide the product. In such embodiments, the facility may benefit from increased traffic in the facility which can result in increased sales.

In some embodiments, a system for leveraging an existing point of sale system to facilitate sale of a product by a third party seller comprises an existing point of sale system, the existing point of sale system configured to receive, from the third party seller, information about the product, establish an entry for the product based on the product information, receive an indication of a retail shopping facility in which to house the product, receive payment from the buyer, and provide, to the third party seller, value related to the payment from the buyer, the retail shopping facility configured to present, to the buyer on behalf of the third party seller, the product.

In some embodiments, a system for storing a product for sale by a third party seller comprises a control circuit, the control circuit communicatively coupled to an existing point of sale system used by a retail sales entity and configured to receive, from the third party seller, information for the product, establish an entry for the product based on the product information, receive an indication of a retail shopping facility of the retail sales entity in which to house the product, and provide, to a buyer, information sufficient to access a locker, the locker located in the retail shopping facility, the locker configured to receive, from the third party seller, the product, store, securely, the product, and present, to the buyer on behalf of the third party seller at the retail shopping facility, the product, and the existing point of sale system used by the retail sales entity and configured to receive payment from the buyer and provide, to the third party seller, value related to the payment from the buyer.

In some embodiments, a method for leveraging an existing point of sale system to facilitate sale of a product by a third party seller comprises receiving, by the existing point of sale system from the third party seller, information for the product, establishing, by the existing point of sale system in a point of sale database, an entry for the product based on the product information, receiving, from the third party seller, the product, receiving, from one of the third party seller and a buyer, an indication of a retail shopping facility in which to house the product, presenting, to the buyer on behalf of the seller, the product at the retail shopping facility, receiving, by the existing point of sale system, payment from the buyer, and providing, by the existing point of sale system to the third party seller, value related to the payment from the buyer.

In some embodiments, a method for storing a product for sale by a third party seller comprises receiving, by a control circuit, information for the product, establishing, by the control circuit, an entry for the product based on the product information, receiving, from one of the third party seller and the buyer, an indication of a retail shopping facility in which to house the product, receiving, at a locker in the retail shopping facility, the product, storing, securely by the locker, the product, providing, by the control circuit to the buyer, information sufficient to access the locker, presenting, to the buyer on behalf of the third party seller at the retail shopping facility, the product, receiving, by an existing point of sale system from the buyer, payment, and providing, by the existing point of sale system to the third party seller, value related to the payment from the buyer.

1. A system for storing a product for sale by a third party seller, the system comprising:
a control circuit, the control circuit communicatively coupled to an existing point of sale system used by a retail sales entity and configured to:
receive, from the third party seller, information for the product;
establish an entry in an existing point of sale system for the product based on the product information;
receive an indication of a retail shopping facility of the retail sales entity in which to house the product; and
provide, to a buyer, information sufficient to access a locker;
the locker located in the retail shopping facility, the locker configured to:
receive, from the third party seller, the product;
store, securely, the product; and
present, to the buyer on behalf of the third party seller at the retail shopping facility, the product; and
the existing point of sale system used by the retail sales entity, the existing point of sale system including a point of sale terminal located in the retail shopping facility configured to:
receive, via the point of sale terminal, payment from the buyer; and
provide, to the third party seller, value related to the payment from the buyer.

2. The system of claim 1, further comprising:
a second retail shopping facility configured to receive, from the third party seller, the product, wherein the existing point of sale system is further configured to arrange transportation for the product from the second retail shopping facility to the retail shopping facility.

3. The system of claim 1, wherein the payment is for an amount, and wherein the value is one of a credit redeemable at the retail shopping facility for the amount and currency equivalent to less than the amount.

4. The system of claim 1, further comprising:
a server, wherein the server is configured to:
create a listing for the product on a website;
present, via the website, the listing for the product; and
receive, from the buyer, an indication of the buyer's desire to purchase the product.

5. The system of claim 4, wherein the existing point of sale system receives the payment from the buyer via the website.

6. The system of claim 4, wherein the server is further configured to:
present, via the website, a menu including an option to reserve a locker at the retail shopping facility;
receive, via the menu, user input to reserve the locker; and
in response to the user input, cause the locker to be reserved.

7. A method for storing a product for sale by a third party seller, the method comprising:
receiving, by a control circuit, information for the product;
establishing, by the control circuit, an entry in an existing point of sale system for a retailer for the product based on the product information;
receiving, from one of the third party seller and a buyer, an indication of a retail shopping facility in which to house the product, wherein the retail shopping facility is associated with the retailer;
receiving, at a locker in the retail shopping facility, the product;
storing, securely by the locker, the product;
providing, by the control circuit to the buyer, information sufficient to access the locker;
presenting, to the buyer on behalf of the third party seller at the retail shopping facility, the product;
receiving, via a point of sale terminal of the existing point of sale system from the buyer, payment, wherein the point of sale terminal is located in the retail shopping facility; and
providing, by the existing point of sale system to the third party seller, value related to the payment from the buyer.

8. The method of claim 7, wherein the receiving the product occurs at a first retail shopping facility and the retail shopping facility in which to house the product is a second retail shopping facility, and further comprising:
arranging transportation for the product from the first retail shopping facility to the second retail shopping facility.

9. The method of claim 7, wherein the payment is for an amount, and wherein the value is one of a credit redeemable at the retail shopping facility for the amount and currency equivalent to less than the amount.

10. The method of claim 7, wherein the receiving the information for the products occurs via a website, and further comprising:
creating a listing for the product;
presenting, via the website, the listing for the product; and
receiving, from the buyer, an indication of the buyer's desire to purchase the product.

11. The method of claim 10, wherein the presenting the product at the retail shopping facility occurs after the receiving of an indication of the buyer's desire to purchase the product.

12. The method of claim 10, wherein the receiving payment from the buyer occurs via the website.

13. The method of claim 10, further comprising:
presenting, via the website, a menu including an option to reserve a locker at the retail shopping facility;
receiving, via the menu, user input to reserve the locker; and
in response to the receiving the user input, causing the locker to be reserved.
